(19) United States
(12) Patent Application Publication
(10) Pub. No.: US 2010/0207470 A1
(43) Pub. Date: Aug. 19, 2010

(54) SPINDLE MOTOR

(76) Inventors: Jin San Kim, Gyunggi-do (KR); Kum Kyung Lee, Gyunggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/424,502

(22) Filed: Apr. 15, 2009

(30) Foreign Application Priority Data
Feb. 13, 2009 (KR) 10-2009-0012099

(51) Int. Cl. H02K 7/08

(52) U.S. Cl. 310/90

(57) ABSTRACT

Disclosed herein is a spindle motor including a journal bearing and a thrust bearing, thus preventing the lack of fluid occurring as a result of the evaporation or scattering of fluid, and making it easy to control the injected amount of fluid. The spindle motor includes a rotating shaft having a thrust plate inserted perpendicularly into the upper portion thereof. A sleeve accommodates and rotatably supports the rotating shaft. A plate is provided such that the sleeve is secured to the plate. An inner cap is secured to the sleeve in such a way as to face the upper surface of the thrust plate, and a first fluid sealing part is defined between the thrust plate and the inner cap. An outer cap is secured to the upper portion of the inner cap, and a second fluid sealing part is defined between the inner and outer caps.

### CROSS REFERENCE TO RELATED APPLICATION(S)

This application claims the benefit of Korean Patent Application No. 10-2009-0012099, filed on Feb. 13, 2009, entitled “Spindle Motof”, which is hereby incorporated by reference in its entirety into this application.

### BACKGROUND OF THE INVENTION

1. Field of the Invention

The present invention relates generally to a spindle motor and, more particularly, to a spindle motor which includes hydrodynamic bearings comprising a journal bearing and a thrust bearing, thus preventing the lack of fluid occurring as a result of the evaporation or scattering of fluid, and making it easy to control the injected amount of fluid.

2. Description of the Related Art

Generally, a spindle motor maintains high precision rotational characteristics, because a bearing housing a rotating shaft therein rotatably supports the rotating shaft. Because of these characteristics, the spindle motor has been widely used as the drive means of hard-disk drives, optical disk drives, magnetic disk drives and other recording media requiring high-speed rotation.

In such a spindle motor, a hydrodynamic bearing is generally used to inject a predetermined fluid between a rotating shaft and a sleeve for the axial support of the rotating shaft so that the rotating shaft may easily rotate, and to generate hydrodynamic pressure when the rotating shaft rotates.

The hydrodynamic bearing may have a dynamic pressure-generating groove so as to generate dynamic pressure using fluid during the rotation of the rotating shaft. Such a dynamic pressure-generating groove may be formed in each of the inner circumferential part of the sleeve which rotatably supports the rotating shaft and a thrust plate which is installed perpendicular to the axial direction of the rotating shaft. One example of the conventional spindle motor is illustrated in FIG. 6.

As shown in FIG. 6, the conventional spindle motor includes a plate 10, a sleeve 20, an armature 30, a rotating shaft 40, a thrust plate 50, a hub 60 and a stopper 70.

The plate 10 is mounted to a device such as a hard-disk drive, and the sleeve 20 is secured to the central portion of the plate 10.

The sleeve 20 rotatably accommodates the rotating shaft 40 therein, and the stopper 70 is secured to the upper portion of the sleeve 20 so as to prevent the removal of the thrust plate 50.

Further, a journal bearing is formed in the inner circumference of the sleeve 20 facing the rotating shaft 40, and a thrust bearing is formed in the upper surface of the sleeve 20 facing the thrust plate 50.

When external power is supplied to the armature 30, the armature 30 forms an electric field so as to rotate the hub 60 on which an optical or magnetic disk is mounted. The armature 30 includes a core 31 which is formed by laminating a plurality of metal sheets and a coil 32 which is wound several times around the core 31.

The rotating shaft 40 axially supports the hub 60, and is inserted into the sleeve 20 to be rotatably supported by the sleeve 20. The thrust plate 50 is secured to the upper portion of the rotating shaft 40.

An upper thrust bearing is provided between the thrust plate 50 and the stopper 70, and a lower thrust bearing is provided between the thrust plate 50 and the sleeve 20. Here, the lower thrust bearing generates fluid dynamic pressure during the rotation of the rotating shaft 40 by using fluid stored between the sleeve 20 and the thrust plate 50, thus floating the thrust plate 50 from the sleeve 20. Further, the upper thrust bearing generates fluid dynamic pressure using fluid between the stopper 70 and the thrust plate 50, thus preventing the floating thrust plate 50 from colliding with the stopper 70.

The hub 60 mounts the optical or magnetic disk (not shown) thereon to rotate it. The hub 60 is provided with a magnet (not shown) which forms an electromagnetic force in conjunction with the electric field formed in the coil 32.

The stopper 70 supports the thrust plate 50, thus preventing the dislocation of the hub 60 and the rotating shaft 40. The stopper 70 is secured to the sleeve 20 in such a way as to face the upper surface of the thrust plate 50.

Further, a fluid sealing part 71 is horizontally formed between the stopper 70 and the upper surface of the thrust plate 50, so that fluid 80 is stored in the fluid sealing part 71. Since the fluid sealing part 71 is horizontally formed, a stronger sealing effect is achieved by the centrifugal force of the fluid during the rotation of the rotating shaft 40.

However, the conventional spindle motor having the above construction is problematic in that, when the stopper 70 is installed to the sleeve 20 and thereafter fluid is injected, it is very difficult to control the injected amount of the fluid. That is, it is impossible to observe the interface of the fluid with the naked eye, so that it is difficult to accurately ascertain the injected amount of the fluid.

Further, the conventional spindle motor is problematic in that it is impossible to intuitively see the lack of fluid resulting from the evaporation or scattering of the fluid while the spindle motor into which the fluid is injected is used, so that the rotating shaft may vibrate or malfunction because of the lack of the fluid.

Further, in order to satisfy the trend for high-speed spindle motors, the amount of fluid stored in the spindle motor must be increased.

### SUMMARY OF THE INVENTION

The present invention has been made in an effort to provide a spindle motor, which uses a dual cap including an inner cap and a transparent outer cap. An upper thrust bearing and a first fluid sealing part are provided between the inner cap and a thrust plate, and a second fluid sealing part is provided between the inner cap and the outer cap. The dual cap allows the spindle motor to store more fluid therein. Further, while fluid is injected or the spindle motor is used, it is possible to more easily and intuitively control the interface of the fluid.

In a spindle motor according to an embodiment of the present invention, the spindle motor includes a rotating shaft having a thrust plate inserted perpendicularly into the upper portion thereof. A sleeve accommodates and rotatably supports the rotating shaft. A plate is provided such that the sleeve is secured to the plate. An inner cap is secured to the sleeve in such a way as to face the upper surface of the thrust plate, and a first fluid sealing part is defined between the thrust plate and the inner cap. An outer cap is secured to the upper portion of the inner cap, and a second fluid sealing part is defined between the inner and outer caps.

The outer cap is made of a transparent material to allow a interface of fluid stored in the second fluid sealing part to be observed from outside.

Further, the sleeve has an inner circumference holding the rotating shaft and a bearing surface facing the thrust plate, with a journal bearing provided between the inner circumference and the rotating shaft using fluid dynamic pressure.

Further, an upper thrust bearing is formed between the thrust plate and the inner cap using fluid dynamic pressure, and a lower thrust bearing is formed between the thrust plate and the bearing surface using fluid dynamic pressure.

The first fluid sealing part is formed between the inner cap and the thrust plate in an axial direction of the rotating shaft.

Further, at least two fluid supply holes are formed in the axial direction in the inner cap to supply fluid from the second fluid sealing part to the first fluid sealing part.

Further, a second fluid sealing part is formed between the outer cap and the inner cap in a direction perpendicular to the axial direction.

A measurement scale is printed on the outer cap to measure the amount of injected fluid.

Further, an OK level of the fluid interface is marked on the measurement scale.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a schematic sectional view illustrating a spindle motor according to the preferred embodiment of the present invention;

FIG. 2 is a partially enlarged sectional view illustrating first and second fluid sealing parts of FIG. 1;

FIG. 3 is a front view illustrating an outer cap of FIG. 1;

FIGS. 4 and 5 are schematic sectional views illustrating the process of assembling an inner cap; and

FIG. 6 is a schematic sectional view illustrating a conventional spindle motor.

### DESCRIPTION OF THE PREFERRED EMBODIMENTS

Hereinafter, a spindle motor according to the preferred embodiment of the present invention will be described in detail with reference to the accompanying drawings.

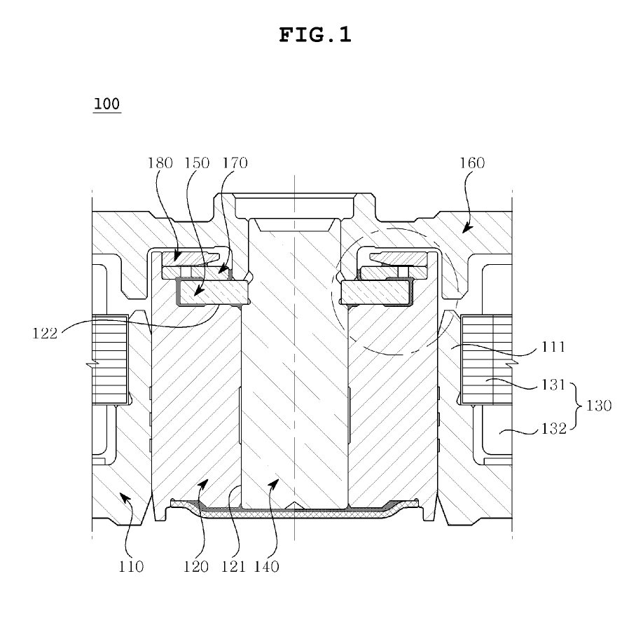

As shown in FIG. 1, a spindle motor 100 according to the preferred embodiment of the present invention includes a plate 110, a sleeve 120, an armature 130, a rotating shaft 140, a thrust plate 150, a hub 160, an inner cap 170 and an outer cap 180.

The plate 110 functions to support the entire spindle motor 100 and is mounted to a device such as a hard disk drive to which the spindle motor 100 is to be installed. Here, the plate 110 is manufactured out of a light material such as an aluminum plate or aluminum alloy plate. However, the plate 110 may be manufactured out of a steel plate.

Further, a coupling part 111 protrudes from the plate 110 in a cylindrical shape, so that the sleeve 120 is coupled to the coupling part 111. The coupling part 111 has in a central portion thereof a coupling hole having the inner diameter which is the same as the outer diameter of the sleeve 120, so that the sleeve 120 is inserted into the coupling hole of the coupling part 111. That is, the sleeve 120 is inserted into the coupling hole, so that the sleeve 120 is secured at a predetermined position. Here, in order to secure the sleeve 120 to the coupling part 111, an adhesion process using an additional adhesive or a laser welding process may be performed. However, the sleeve 120 may be secured to the coupling part 111 by press-fitting the sleeve 120 into the coupling hole with a predetermined amount of pressure.

The sleeve 120 functions to rotatably support the rotating shaft 140 and has a hollow cylindrical shape, with hydrodynamic bearings provided in the inner circumferential part 121 which faces the rotating shaft 140 and a bearing surface 122 which faces the thrust plate 150. In detail, a journal dynamic pressure-generating groove (not shown) is formed in the inner circumferential part 121 of the sleeve 120 to form a journal bearing between the sleeve 120 and the rotating shaft 140. Fluid is stored between the inner circumferential part 121 and the rotating shaft 140. The journal dynamic pressure-generating groove generates fluid dynamic pressure using the fluid stored between the sleeve 120 and the rotating shaft 140 during the rotation of the rotating shaft 140, thus maintaining a non-contact state between the rotating shaft 140 and the sleeve 120. According to this embodiment, the journal dynamic pressure-generating groove is formed in the inner circumferential part 121 of the sleeve 120. However, the journal dynamic pressure-generating groove may be formed in the outer circumference of the rotating shaft 140.

When external power is supplied to the armature 130, the armature 130 forms an electric field so as to rotate the hub 160 on which an optical or magnetic disk is mounted. The armature 130 includes a core 131 which is formed by laminating a plurality of metal sheets and a coil 132 which is wound several times around the core 131.

The core 131 is secured to the outer circumference of the coupling part 111 of the plate 110, and the coil 132 is wound on the core 131. Here, the coil 132 forms an electric field using an external current applied to the coil 132, thus rotating the hub 160 using electromagnetic force generated between the coil 132 and the magnet (not shown) of the hub 160.

The rotating shaft 140 functions to axially support the hub 160. The rotating shaft 140 is inserted into and rotatably supported by the sleeve 120. Meanwhile, the thrust plate 150 is secured to the upper portion of the rotating shaft 140. Here, in order to secure the thrust plate 150 inserted into the upper portion of the rotating shaft 140 to the rotating shaft 140, an additional laser welding process may be performed. However, by applying predetermined pressure to the thrust plate 150, the thrust plate 150 may be press-fitted into the rotating shaft 140.

The thrust plate 150 is secured to the rotating shaft 140. An upper thrust bearing is formed between the thrust plate 150 and the inner cap 170, and a lower thrust bearing is formed between the thrust plate 150 and the bearing surface 122 of the sleeve 120. Upper and lower thrust dynamic pressure-generating grooves (not shown) are formed in a portion of the thrust plate 150 facing the inner cap 170 and a portion of the thrust plate 150 facing the sleeve 120, respectively. The lower thrust dynamic pressure-generating groove generates fluid dynamic pressure using fluid stored between the sleeve 120 and the thrust plate 150 during the rotation of the rotating shaft 140, thus floating the thrust plate 150 from the bearing surface 122 of the sleeve 120 to a predetermined height. Further, the upper thrust dynamic pressure-generating groove generates fluid dynamic pressure using fluid stored between the inner cap 170 and the thrust plate 150 during the rotation of the rotating shaft 140, thus generating a force for pushing the thrust plate 150 from the inner cap 170. That is, by the upper and lower thrust hydrodynamic bearings, the thrust plate 150 is in contact with neither the inner cap 170 nor the sleeve 120 during the rotation of the rotating shaft 140. According to this embodiment, the thrust dynamic pressure-generating grooves are formed in the thrust plate 150. However, the thrust dynamic pressure-generating grooves may be formed in the bearing surface 122 of the sleeve 120 and the inner cap 170.

The hub 160 mounts the optical or magnetic disk thereon to rotate it, and has the shape of a disk. Further, the hub 160 is provided such that the rotating shaft 140 is secured to the central portion of the hub 160. The magnet (not shown) is attached to the inner circumference of the hub 160 in such a way as to face the armature 130, and forms a magnetic field to generate an electromagnetic force in conjunction with an electric field formed in the coil 132.

The inner cap 170 supports the thrust plate 150 to prevent the removal of the hub 160 and the rotating shaft 140, with the upper thrust bearing formed between the inner cap 170 and the thrust plate 150. The inner cap 170 is secured to the sleeve 120 in such a way as to face the upper surface of the thrust plate 150. Here, the inner cap 170 has an annular disk shape, and a first fluid sealing part 171 is formed between the inner cap 170 and the thrust plate 150 in a vertical direction (the axial direction of the rotating shaft), so that fluid is stored in the first fluid sealing part 171.

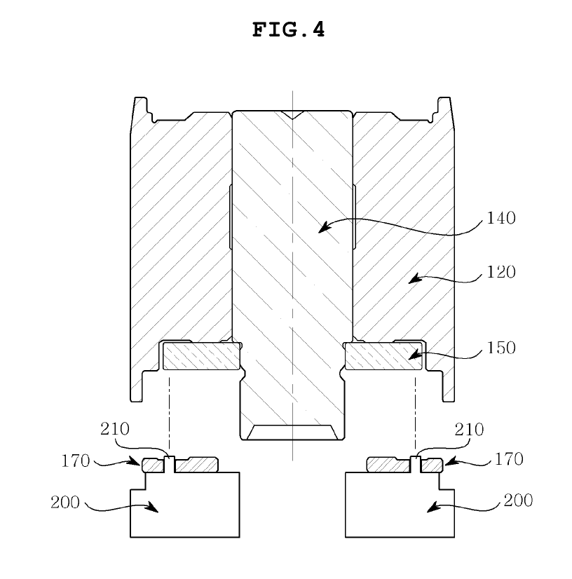

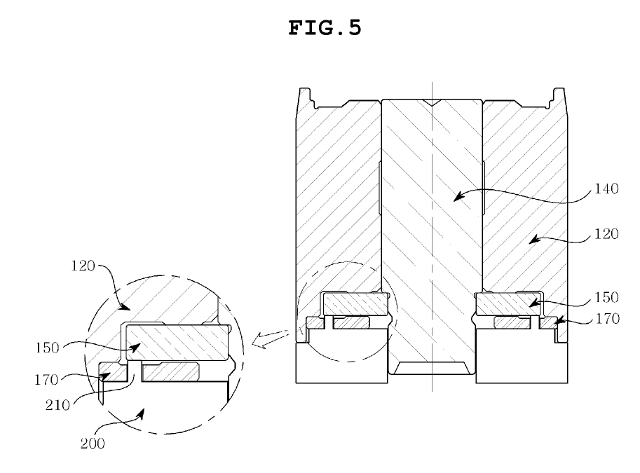

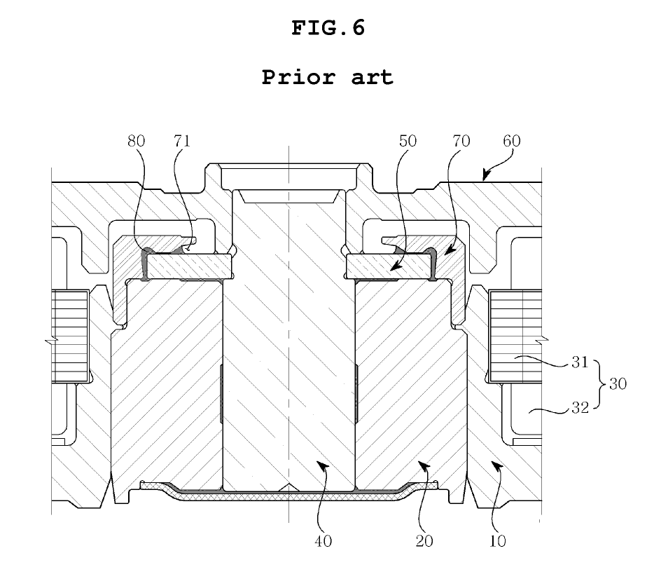

Further, at least two fluid supply holes 172 are formed in the inner cap 170 in such a way as to face each other, and supply fluid stored between the inner and outer caps 170 and 180 to the thrust plate 150. During the installation of the inner cap 170, the protrusions 210 of a jig 200 are inserted into the corresponding fluid supply holes 172. That is, during the installation of the inner cap 170, the protrusions 210 of the jig 200 are inserted into the fluid supply holes 172, so that it is easier to place the inner cap 170 at a precise position and control a gap between the inner cap 170 and the thrust plate 150. The process of assembling the inner cap 170 will be described below in detail with reference to FIGS. 4 and 5.

A second fluid sealing part 181 is formed between the outer cap 180 and the inner cap 170 in a horizontal direction (the direction perpendicular to the rotating shaft). To this end, the outer cap 180 is secured to the sleeve 120 in such a way as to face the upper portion of the inner cap 170. According to this embodiment, the outer cap 180 forms the second fluid sealing part 181 so as to store more fluid, thus allowing the spindle motor 100 to contain more fluid therein, therefore preventing the vibration of the rotating shaft 140 or the malfunction of the spindle motor 100 due to a lack of the fluid resulting from its evaporation or scattering.

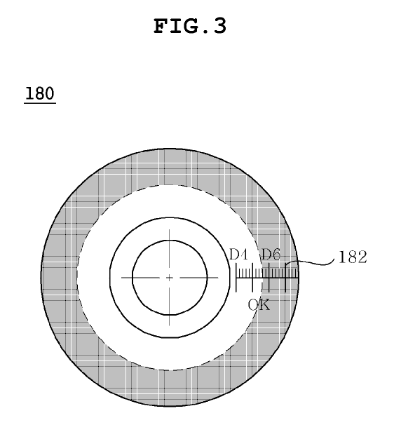

Further, the outer cap 180 of this embodiment may be made of a transparent material so as to control the interface of the fluid formed in the second fluid sealing part 181. As shown in FIG. 3, measurement scales 182 may be marked on the outer cap 180 to measure the position of the fluid interface. That is, the position of the fluid interface is measured by the measurement scales 182, thus controlling the amount of the fluid during a fluid injection process, and measuring the amount of fluid which has evaporated or scattered during the use of the spindle motor 100.

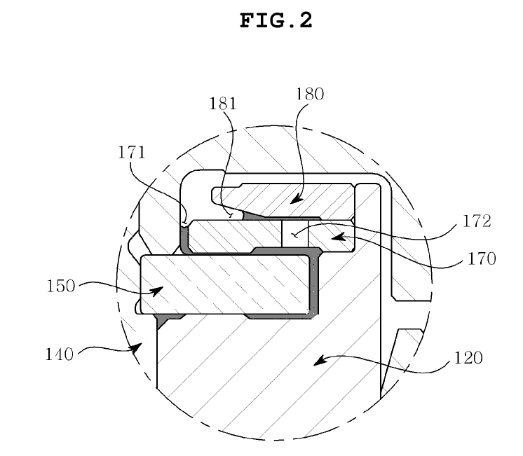

The detailed construction of the inner cap 170 and the outer cap 180 is shown in FIG. 2. The first and second fluid sealing parts 171 and 181 will be described in detail with reference to FIG. 2.

As shown in the partially enlarged view of FIG. 2, the thrust plate 150 of the rotating shaft 140 is positioned between the sleeve 120 and the inner cap 170. The first fluid sealing part 171 is formed between the inner cap 170 and the thrust plate 150, and to be more exact, between the inner cap 170 and an end of the hub 160. The second fluid sealing part 181 is formed between the outer cap 180 and the inner cap 170. In comparison with the conventional fluid sealing part, the present invention further includes the second fluid sealing part 181 to store more fluid, thus securing the reliable driving characteristics of the spindle motor 100.

Meanwhile, the fluid stored in the second fluid sealing part 181 is supplied through the fluid supply holes 172 of the inner cap 170 to the first fluid sealing part 171, thus mitigating excessive dynamic pressure when it is generated between the thrust plate 150 and the inner cap 170 or between the thrust plate 150 and the sleeve 120.

Meanwhile, the interface of fluid in the first fluid sealing part 171 is formed in the axial direction of the rotating shaft 140, namely, in the vertical direction, thus allowing the amount of fluid injected into the first fluid sealing part 171 to be observed or measured with the naked eye. In contrast, the interface of fluid in the second fluid sealing part 181 is formed in a direction perpendicular to the rotating shaft 140, namely, in a horizontal direction. According to this embodiment, when the outer cap 180 is made of a transparent material, the interface of fluid in the second fluid sealing part 181 may be observed with the naked eye.

Further, as shown in FIG. 3, the measurement scales 182 are printed on the outer cap 180, thus allowing the interface of fluid to be observed by a simple optical instrument such as a microscope or by the naked eye, and thereby controlling the amount of fluid which is injected. Further, an OK level of the fluid interface may be marked on the measurement scales 182. That is, a user measures the fluid interface using an optical instrument such as a microscope or with the naked eye to determine whether the fluid interface is located within the OK level, thus more easily distinguishing a non-defective from a defective product.

As described above, in order to prevent excessive dynamic pressure, the fluid supply holes 172 are formed in the inner cap 170 to couple the first fluid sealing part 171 with the second fluid sealing part 181. The fluid supply holes 172 may be used to place the inner cap 170 at a precise position during the installation of the inner cap 170 and to control the gap between the inner cap 170 and the thrust plate 150. This is shown in FIGS. 4 and 5.

As shown in FIGS. 4 and 5, in order to install the inner cap 170 to the sleeve 120, the jig 200 is used. The jig 200 is provided with two protrusions 210 which are inserted into the fluid supply holes 172 of the inner cap 170. When the protrusions 210 are inserted into the corresponding fluid supply holes 172, it is preferable that the upper end of each protrusion 210 protrude upwards from the inner cap 170. That is, the protrusions 210 protruding upwards from the inner cap 170 are in close contact with the thrust plate 150, as shown in FIG. 5, thus maintaining the gap between the inner cap 170 and the thrust plate 150. That is, by adjusting the height of each protrusion 210, the gap between the inner cap 170 and the thrust plate 150 can be more easily controlled.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

As described above, the present invention provides a spindle motor, which uses a dual cap having an inner cap and an outer cap, thus ensuring an additional fluid sealing part, therefore allowing the spindle motor to store more fluid therein.

Further, the outer cap is made of a transparent material, thus allowing a user to naturally observe the interface of fluid with the naked eye, therefore making it easier to control the amount of fluid which is injected and the shortness of fluid.

What is claimed is:

1. A spindle motor, comprising:
a rotating shaft having a thrust plate inserted perpendicularly into an upper portion of the rotating shaft;
a sleeve accommodating the rotating shaft and rotatably supporting the rotating shaft;
a plate provided such that the sleeve is secured to the plate;
an inner cap secured to the sleeve in such a way as to face an upper surface of the thrust plate, with a first fluid sealing part defined between the thrust plate and the inner cap; and
an outer cap secured to an upper portion of the inner cap, with a second fluid sealing part defined between the inner cap and the outer cap.

2. The spindle motor as set forth in claim 1, wherein the outer cap is made of a transparent material to allow a interface of fluid stored in the second fluid sealing part to be observed from outside.

3. The spindle motor as set forth in claim 1, wherein the sleeve comprises an inner circumference holding the rotating shaft and a bearing surface facing the thrust plate, with a journal bearing provided between the inner circumference and the rotating shaft using fluid dynamic pressure.

4. The spindle motor as set forth in claim 3, wherein an upper thrust bearing is formed between the thrust plate and the inner cap using fluid dynamic pressure, and a lower thrust bearing is formed between the thrust plate and the bearing surface using fluid dynamic pressure.

5. The spindle motor as set forth in claim 4, wherein the first fluid sealing part is formed between the inner cap and the thrust plate in an axial direction of the rotating shaft.

6. The spindle motor as set forth in claim 5, wherein at least two fluid supply holes are formed in the axial direction in the inner cap to supply fluid from the second fluid sealing part to the first fluid sealing part.

7. The spindle motor as set forth in claim 6, wherein a second fluid sealing part is formed between the outer cap and the inner cap in a direction perpendicular to the axial direction.

8. The spindle motor as set forth in claim 7, wherein a measurement scale is printed on the outer cap to measure an amount of injected fluid.

9. The spindle motor as set forth in claim 8, wherein an OK level of the fluid interface is marked on the measurement scale.

10. The spindle motor as set forth in claim 2, wherein the sleeve comprises an inner circumference holding the rotating shaft and a bearing surface facing the thrust plate, with a journal bearing provided between the inner circumference and the rotating shaft using fluid dynamic pressure.

11. The spindle motor as set forth in claim 10, wherein an upper thrust bearing is formed between the thrust plate and the inner cap using fluid dynamic pressure, and a lower thrust bearing is formed between the thrust plate and the bearing surface using fluid dynamic pressure.

12. The spindle motor as set forth in claim 11, wherein the first fluid sealing part is formed between the inner cap and the thrust plate in an axial direction of the rotating shaft.

13. The spindle motor as set forth in claim 12, wherein at least two fluid supply holes are formed in the axial direction in the inner cap to supply fluid from the second fluid sealing part to the first fluid sealing part.

14. The spindle motor as set forth in claim 13, wherein a second fluid sealing part is formed between the outer cap and the inner cap in a direction perpendicular to the axial direction.

15. The spindle motor as set forth in claim 14, wherein a measurement scale is printed on the outer cap to measure an amount of injected fluid.

16. The spindle motor as set forth in claim 15, wherein an OK level of the fluid interface is marked on the measurement scale.
